(19) United States
(12) Patent Application Publication
(10) Pub. No.: US 2018/0293740 A1
(43) Pub. Date: Oct. 11, 2018

(54) DATA FUSION PROCESSING TO IDENTIFY OBSCURED OBJECTS

(71) Applicant: Arete Associates, Northridge, CA (US)

(72) Inventors: James Thomas Murray, Longmont, CO (US); Charles Jason Seely, Niwot, CO (US); Harold H. Wadleigh, III, Linden, VA (US); Brian William Lang, Alexandria, VA (US)

(21) Appl. No.: 16/002,874

(22) Filed: Jun. 7, 2018

Related U.S. Application Data
(63) Continuation of application No. 14/796,201, filed on Jul. 10, 2015.
(60) Provisional application No. 62/023,118, filed on Jul. 10, 2014.

(51) Int. Cl. G06T 7/246; G01S 17/89; H04N 5/33; G01S 17/02; G01S 7/48; G01S 13/86; G01S 13/89; G01S 15/89

(52) U.S. Cl. CPC G06T 7/251; G01S 17/89; H04N 5/33; G01S 15/89; G01S 7/4808; G01S 13/867; G01S 13/89; G01S 17/023

(57) ABSTRACT

Embodiments herein provide for imaging and identification of obscured objects. One system herein includes a volumetric data source comprising three dimensional (3D) imaging data of a scene, and a two dimensional (2D) image source comprising 2D image data of the scene. The system also includes a processor operable to process the 2D data and the 3D data to generate a model of a material obscuring an object in the scene from sensors providing the 2D data and the 3D data. The processor is further operable to refine the model with detection data of the material from the volumetric data source, to detect the material obscuring the object based on the refined model, to generate an image of the scene, and to remove data pertaining to the material from the image to reveal the object in the image.

### CROSS REFERENCE TO RELATED APPLICATIONS

This patent application is a continuation patent application claiming priority to, and thus the benefit of, U.S. patent application Ser. No. 14/796,201 (filed Jul. 10, 2015), which claims priority to, and thus the benefit of an earlier filing date from, U.S. Provisional Patent Application No. 62/023,118 (filed Jul. 10, 2014), the entire contents of each of which are hereby incorporated by reference.

### BACKGROUND

Objects can be obscured from view in a variety of ways. For example, in a battlefield, smoke, chemical clouds (e.g., poisonous gas), and fog can obscure enemy combatants making navigation and battlefield assessments unmanageable. And, dust and fog can obscure a landing zone for an aircraft such as a helicopter. Visually removing these obscurants can create safer operating conditions in whatever the situation.

### SUMMARY

Systems and methods presented herein provide for imaging an object obscured by a material. In one embodiment, a system for imaging obscured objects includes a volumetric data source comprising three dimensional (3D) image data of a scene and a two dimensional (2D) image source comprising 2D image data of the scene. The system also includes a processor operable to process the 2D data and the 3D data to generate a model of a material obscuring an object in the scene from sensors providing the 2D data and the 3D data. The processor is further operable to refine the model with detection data of the material from the volumetric data source, to detect the material obscuring the object based on the refined model, to generate an image of the scene, and to remove data pertaining to the obscuring material from the image to reveal the object in the image.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary imaging system.

FIG. 2 is a flowchart illustrating an exemplary process of the imaging system of FIG. 1.

FIG. 3 is a block diagram of an exemplary lidar imaging system.

FIGS. 4 and 5 are graphs illustrating exemplary lidar results of the lidar imaging system of FIG. 3.

FIG. 6 illustrates an exemplary camera view of the lidar imaging system of FIG. 3.

FIG. 7 illustrates virtual views that have been computed based on data from the lidar imaging system of FIG. 3.

FIG. 8 illustrates exemplary processing nodes of the imaging system of FIG. 1.

FIG. 9 illustrates an exemplary generation of a collection model of a processing node in FIG. 8.

FIGS. 10A and 10B illustrate exemplary lidar collections used to generate a volumetric propagation model in another processing node of FIG. 8.

FIG. 11 illustrates fitting a surface to incoming lidar data.

FIG. 12 illustrates angular coordinates of volumetric information being exemplarily associated with data extracted from 2D image data.

FIGS. 13A and 13B illustrate exemplary updates to a world model of a processing node of FIG. 8.

FIGS. 14A-14D illustrate experimental results of a cloud structure extracted from lidar data.

FIGS. 15A-15B are photographs of experimental results achieved by the imaging system of FIG. 1.

FIG. 16 is a block diagram of an exemplary computing system in which a computer readable medium provides instructions for performing methods herein.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention and are to be construed as being without limitation to such specifically recited examples and conditions. As a result, the invention is not limited to the specific embodiments or examples described below.

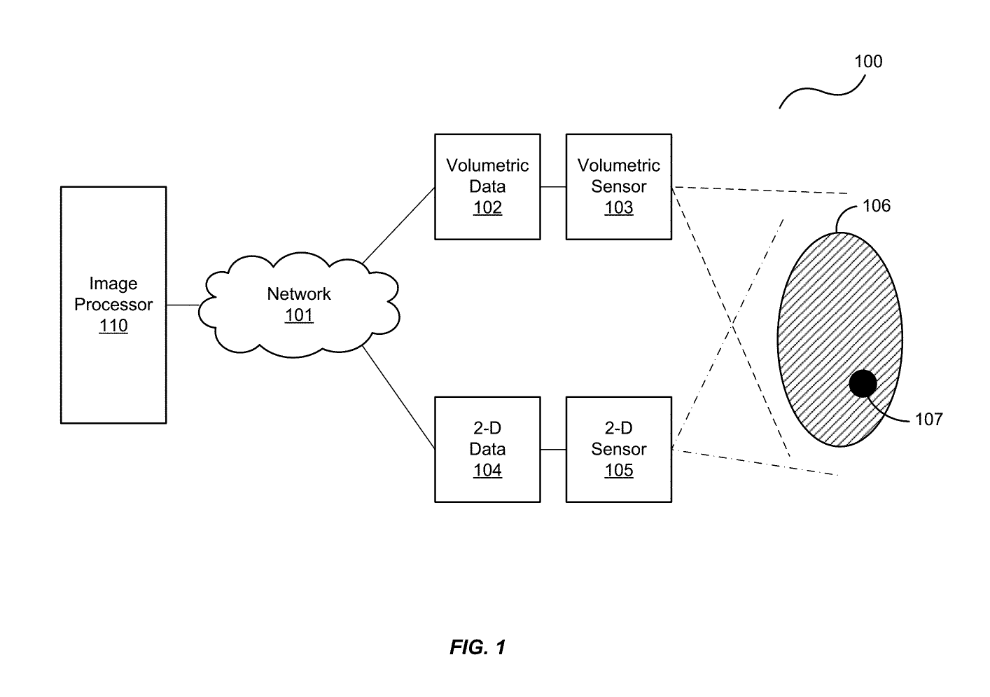

FIG. 1 is a block diagram of an exemplary imaging system 100. The imaging system 100 includes an image processor 110 that is operable to reveal an object 107 in a scene that is obscured by some material 106, such as fog, smoke, chemical haze, or the like. The image processor 110 is operable to process volumetric data (i.e., 3D imaging data) from a volumetric data source 102 to generate a model of the scene where the object 107 is being obscured by the material 106. For example, the volumetric data source 102 may receive 3D imaging data from a volumetric sensor 103, such as a lidar system or other 3D imaging device. In generating the model, the image processor 110 also processes 2D image data from a 2D data source 104 and associates that data with the 3D imaging data. The 2D data source 105 may receive the data from a 2D sensor 105, such as a digital camera, an infrared camera, or the like.

The image processor 110 can be configured in a variety of ways as a matter of design choice. For example, the image processor 110 may be a remote computer system receiving data from the volumetric data source 102 and the 2D data source 104 through a communication network 101 such as the Internet. Alternatively or additionally, the image processor 110 may be co-located with the volumetric sensor 103 and the 2D sensor 105 to provide on-scene image processing to reveal the object 107. Accordingly, the image processor 110 is any system, device, software, or combination thereof operable to process 3D imaging data with 2D image data to generate an image of a scene and reveal an object in that image that is obscured from view. In other words, the image processor 110 unobscures an object in an image. Other exemplary embodiments are shown and described below in greater detail.

As used herein, imaging data is generally data that can be used to generate an image whereas image data generally regards digital data in the form of an image. However, the invention is not intended to be limited to various types of forms of imaging/image data as other forms of data may be used including thermal and chemical data. In this regard, the image processor 110 is operable to process multiple forms of data (e.g., data fusion) to render an image of the object 107 unobscured by the material 106.

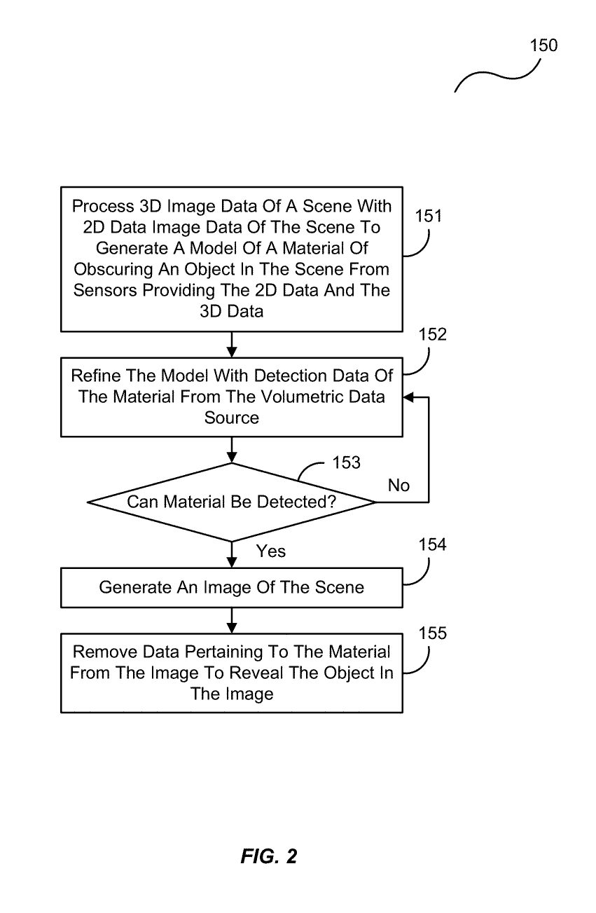

In FIG. 2, a flowchart illustrates an exemplary process 150 of the imaging system 100 of FIG. 1. In this embodiment, the processor 110 processes 3D imaging data of a scene with 2D image data of the scene to generate a model of the material 106 obscuring the object 107, in the process element 151. Again, the 3D imaging data and the 2D image data of the scene arrive from the volumetric data source 102 and the 2D image data source 104, respectively. Examples of the data sources 102 and 104 include storage devices (e.g., computer disk drives, solid-state drives, databases, etc.). The data sources 102 and 104 may be coupled to their respective sensors 103 and 105. Alternatively or additionally, the data sources 102 and 104 may be remotely located from the sensors 103 and 105. Accordingly, the data sources 102 and 104 are any systems, devices, software, or combinations thereof operable to provide their respective types of data (i.e., 3D imaging data and 2D image data) to the image processor 110.

Again, the processor 110 uses the data from the data sources 102 and 104 to generate a model of the material 106 obscuring the object 107. This model is used to divine the shape, nature, and/or type of the material 106 obscuring the object 107 so that the material 106 can be effectively removed from an image generated by the processor 110. The processor 110 refines the model, in the process element 152, based on detection data of the material 106 obtained from the volumetric data source 102. For example, a lidar system may be operable to generate a volumetric representation of the material 106 which includes a representation of the surface area of the material 106. Then, the lidar system and/or another detection system may also gather data pertaining to the makeup of the material (e.g., chemical, biological, etc.). This surface area data and/or material composition data may be fed to the processor 110 via the volumetric data source 102 so as to refine that model and determine its physical and optical characteristics so as to detect the material, in the process element 153.

If the material cannot be readily detected in the process element 153, then the processor 110 further refines the model with additional data about the material 106, in the process element 152. Otherwise, when the processor 110 detects the material, the processor 110 generates an image of the scene, in the process element 154, using for example the 2D data from the 2D image source 104. The processor 110 then removes the data pertaining to the material 106 from the image to reveal the object 107 in the image, in the process element 155. In other words, the processor 110 in essence erases the material 106 from the generated image so as to reveal a clearer view of the object 107 in the image.

The processor 110 can operate in real time so as to produce a video of the scene. For example, the processor 110 may generate a number of images with each image operating as a “frame” in a video stream. In this regard, the processor 110 may continually refine the model and “erase” data pertaining to the obscuring material 106 in the scene so as to show any solid objects, moving or not, in the scene and thus in the generated video. Other exemplary embodiments are shown in greater detail below that point out how an object is revealed in a scene and the how the image is subsequently rendered.

Generally, the processor 110, using 3D sensing data and 2D sensing data, produces a parametrically rendered 3D “world model”. This processor 110 is particularly relevant for processing lidar and/or radar data along with camera imagery through a volume (i.e., a 3D scene) having degraded light-propagation attributes. Utilizing information from multiple data streams, surface model properties may be accumulated and used within the 3D world model to provide subsequent image renderings with illumination, orientation, volumetric parameters, and/or other attributes that differ from the physical conditions during which the source data was collected.

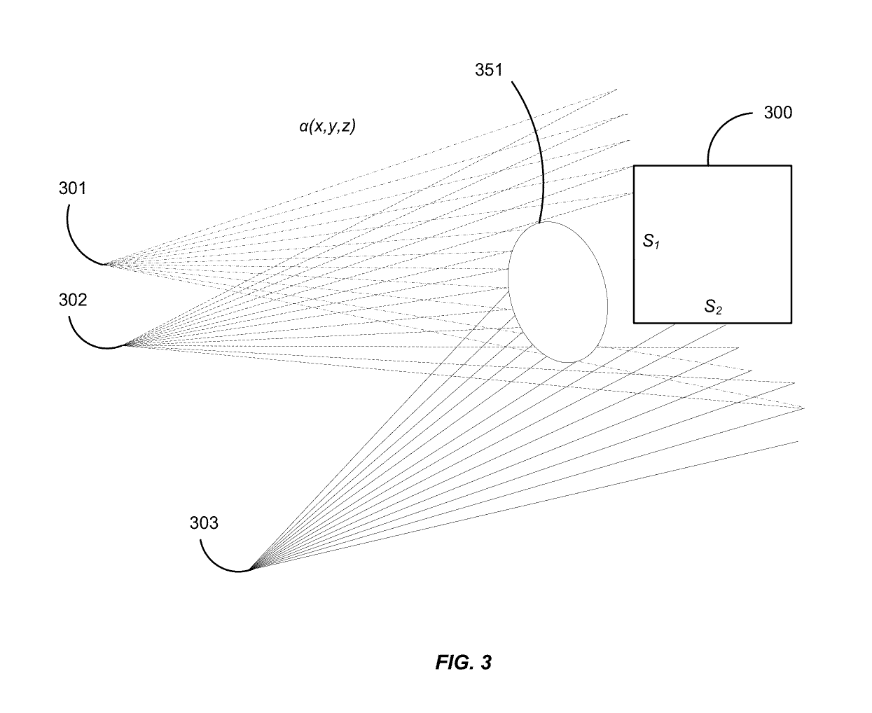

FIGS. 3-7 illustrate various examples of lidar data collection, processing, and data fusion (e.g., with 2D data) consistent with the embodiments herein. For example, in FIG. 3, lidar data may be obtained by projecting a short optical pulse from a vantage point 301. The 2D imaging system may be positioned at a vantage point 302. Utilizing the data from both sensing systems, a computer rendered image from a vantage point 303 can be produced in which an obscuration 351 is removed to reveal surfaces S₁ and S₂ of an object 300 in the scene. This example merely illustrates that the different vantage points do not need to be the same.

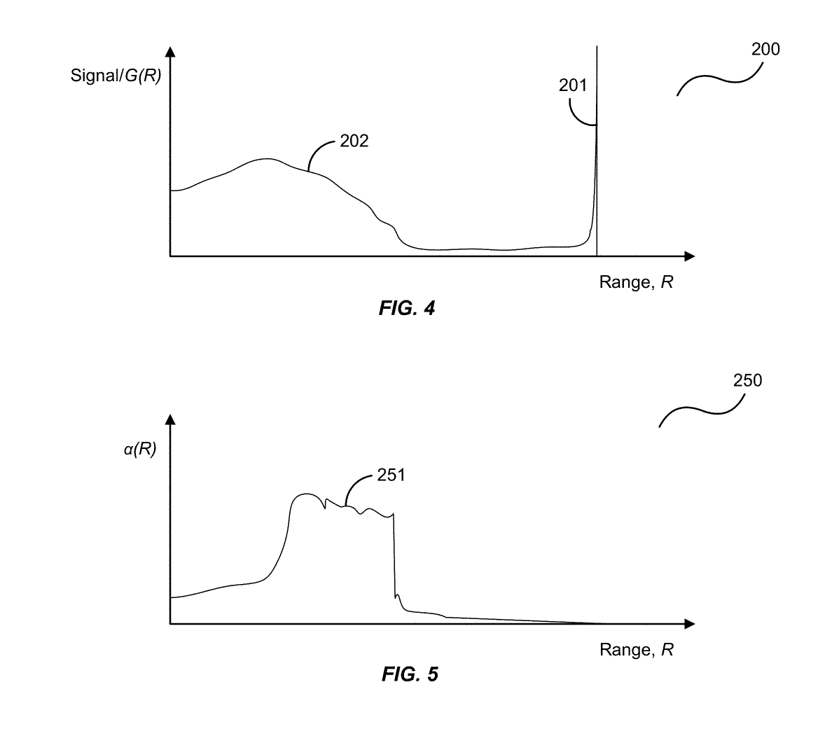

Lidar return data can be collected by a receiver and a range response of the lidar system can be computed. The range response G(R) of the lidar system (illustrated in FIG. 4) generally depends on the optical system, laser focus, receiver focal properties, and aperture sizes. The range response G(R) may have a 1/R² dependence. However, and more typically, this range response is a system dependent function established through engineering calculations and/or calibration measurements.

After compensating for the system range response G(R), the measured sensor signal (e.g., retained by the volumetric data source 102) may be compensated for the range response function. The resulting signal series (element 202 of FIG. 4) may generally consist of signals from distributed scatterers, which partially reflect light back towards the receiver while attenuating the laser beam. The signal series may also include signals (e.g., element 201 of FIG. 4) from hard targets, such as from the object 300.

Hard targets that are much larger than the laser beam generally result in a “shadow” in the signal series since laser light from later times than the round trip time to the hard target cannot be generated by scattering from behind the target. In other instances, the laser beam may be larger than a hard target (e.g., telephone lines, power cables, guide wires, etc.). In these instances, the distributed scatter signal may still be observable at distances that are further than the hard target.

In general, round-trip range-dependent optical transmission is dependent on attenuation processes along the laser path. This can be written as

T(R)=e^{[-2ƒ}^{₀}^{^{R}}^{(a}^{_{abs}}^{(r)+a}^{_{scat}}^{(r)+a}^{_{obs}}^{(r))dr]} Equation (1)

where a_{abs}(r) generally refers to the intrinsic background absorption, a_{scat}(r) generally refers to the scattering related attenuation that also results in backscatter to the receiver, and a_{obs}(r) generally refers to the obstruction related attenuation of the laser beam for the cases where the laser beam is partially obstructed by smaller hard targets.

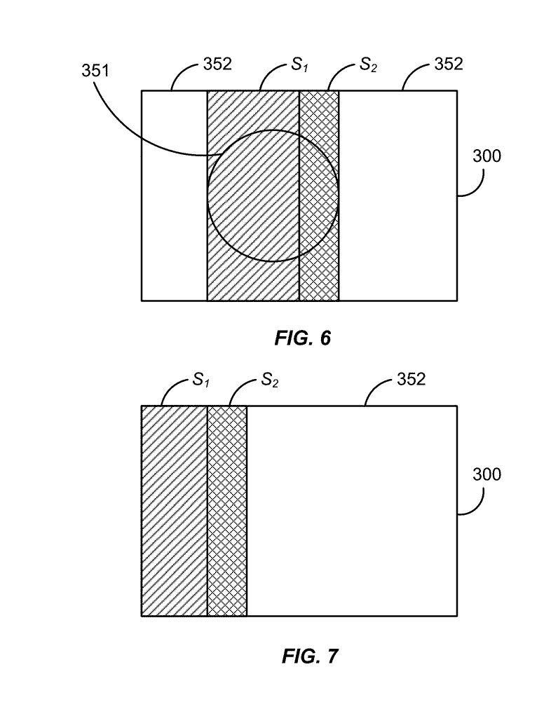

Since no light propagates past the surface object, there are no signals from longer ranges. Given the range dependent return signal, the optical attenuation can be calculated over a range out to the surface as exemplarily illustrated in FIG. 5. Element 251 shows the attenuation from a spatially concentrated region of attenuating material which exemplarily illustrate one volumetric property (i.e., attenuation).

The range dependence on the received signal should have a component that is proportional to T(R) to account for both the outgoing and incoming light along the beam path. The range dependence should also be proportional to the a_{scat}(r) since the proportion of light backscattered towards the receiver depends on the density of scatters and their optical cross-sections. Provided that some information is acquired regarding the background absorption through the air, the signal series may be used to extract the range dependent scattering attenuation a_{scat} (r).

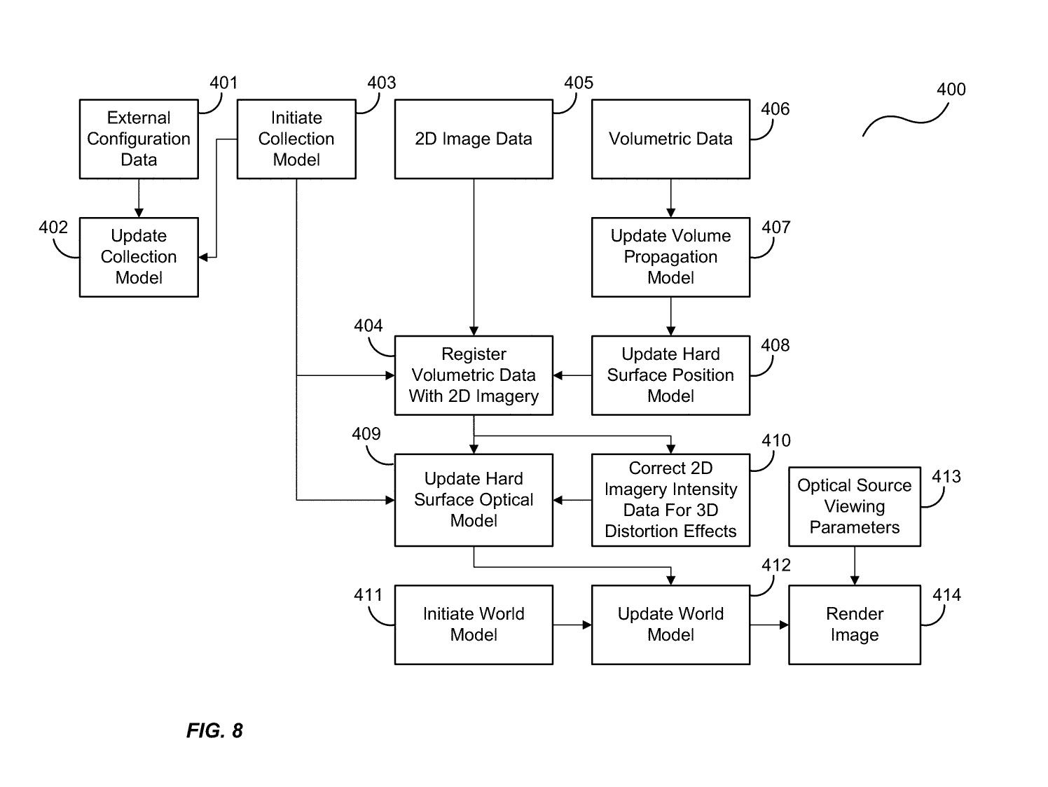

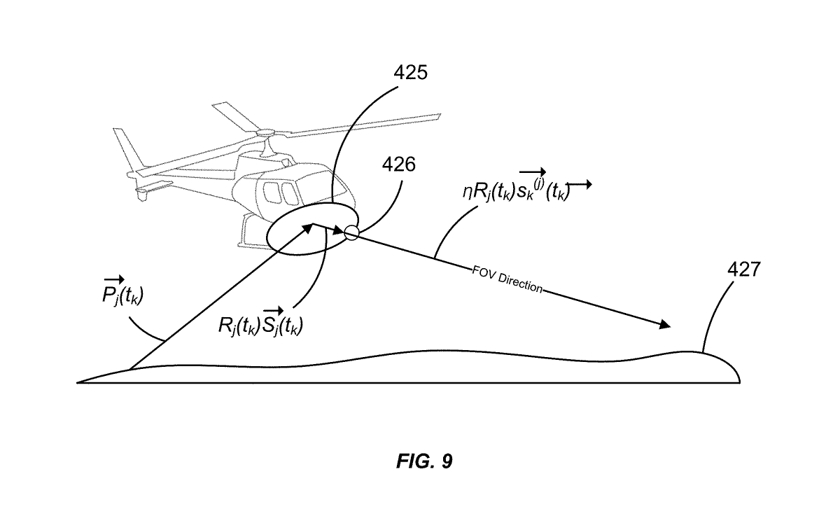

FIG. 6 illustrates a camera view of the surfaces S₁ and S₂ of the object 300 from the vantage point 302 of FIG. 3. The region 351 of the view is that obscured by the volumetric obscurant shown in FIG. 3. FIG. 7 illustrates that the surfaces S₁ and S₂ of 300 can still be computed from a virtual vantage point 303 that is different from the observed vantage point because the image degradation from the obscurant is significantly removed from the vantage point 303.

Hard target returns sensed in the lidar data may be used to identify the 3D positions of surfaces. And, given the volumetric attenuation distribution obtained with the lidar system, 2D image data collected from a camera (e.g., FIG. 6) may be corrected by using calculated transmission profiles. The corrected 2D image data may be registered to 3D point clouds obtained from the hard target returns on the lidar system.

The 3D world model thus accumulates surfaces and surface properties and is updated, for example, to include emission properties of surfaces based on the registered corrected 2D imagery as well as the return intensities associated with the point clouds. If the 2D imagery occurs in a long-wavelength infrared (LWIR) band, the surface emissions may be primarily thermal in nature, and an angular emission pattern and surface effective temperature may be extrapolated from the data.

In the case of visible radiation (e.g., where emissions are due to solar illumination), surface emissions may be used along with the known information on solar position, calculated shadows from structures, and atmospheric scattering distributions to extract parameters for a Bidirectional Reflectance Distribution Function (BDRF) model for detected surfaces. These parameters are held within the world model and used for image rendering.

Since image rendering is based on the measured surface properties after corrections for atmospheric distortions or attenuation, renderings can be simulated for conditions differing from the conditions when the data was taken. For example, the vantage point for the rendered image may be different than the vantage point of any of the sensors used to collect the data. Illumination patterns or colors may be chosen to provide surface shading that best displays contrast for important observable features. And, thermal emissions in the IR may be simulated using arbitrary temperatures. The world model may be continuously updated using data accumulated from a sequence of orientations and positions so that the resulting renderings provide higher quality images than could be produced from single frames of data.

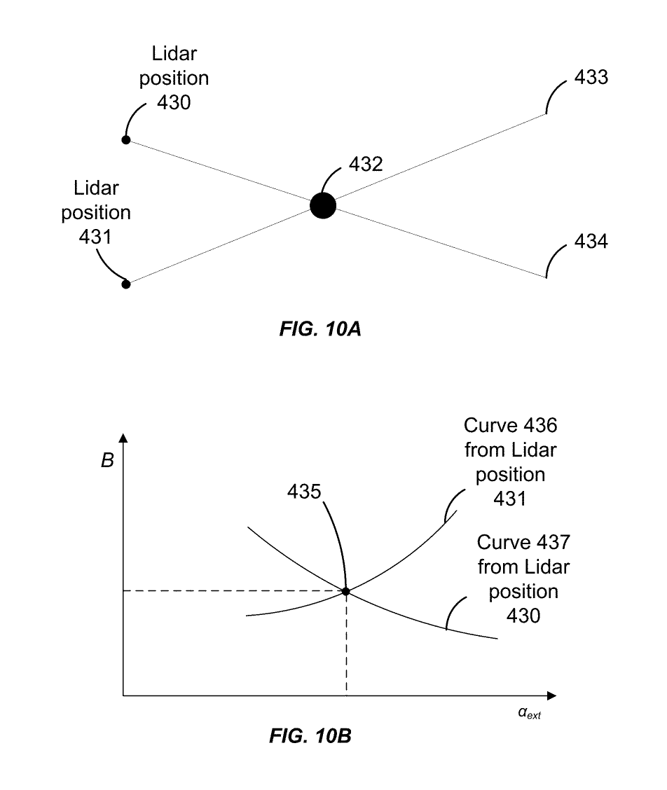

The 2D imagery can include multiple images at multiple wavelengths and can even include polarization data. The 3D imagery can include Angle-Range Point Clouds from lidar, radar data (e.g., millimeter wave), or combinations thereof. Accordingly, the invention is not intended to be limited to any particular type of data. General processing nodes are shown and described in FIG. 8 to illustrate how various data types may be used to implement and update the world model. In this general embodiment, arrows may show data flow, but not necessarily temporal sequences since different processes may be iterative and not necessarily synchronous. And, some functional nodes may repeat at faster rates than other nodes while other nodes may occur in post-processing and preprocessing.

The processing node 403 in FIG. 8 describes the initiation of the collection model. The collection model includes geometric parameters and collection parameters for processing and registering 2D image data and 3D volumetric data. Such parameters include the geometric orientations and positions of receivers as well as transmitters/illuminators. The model includes the categorization, characterization, and calibration data for each input data stream to the system. Initiating the collection model also includes the specification of static parameters related to data collection.

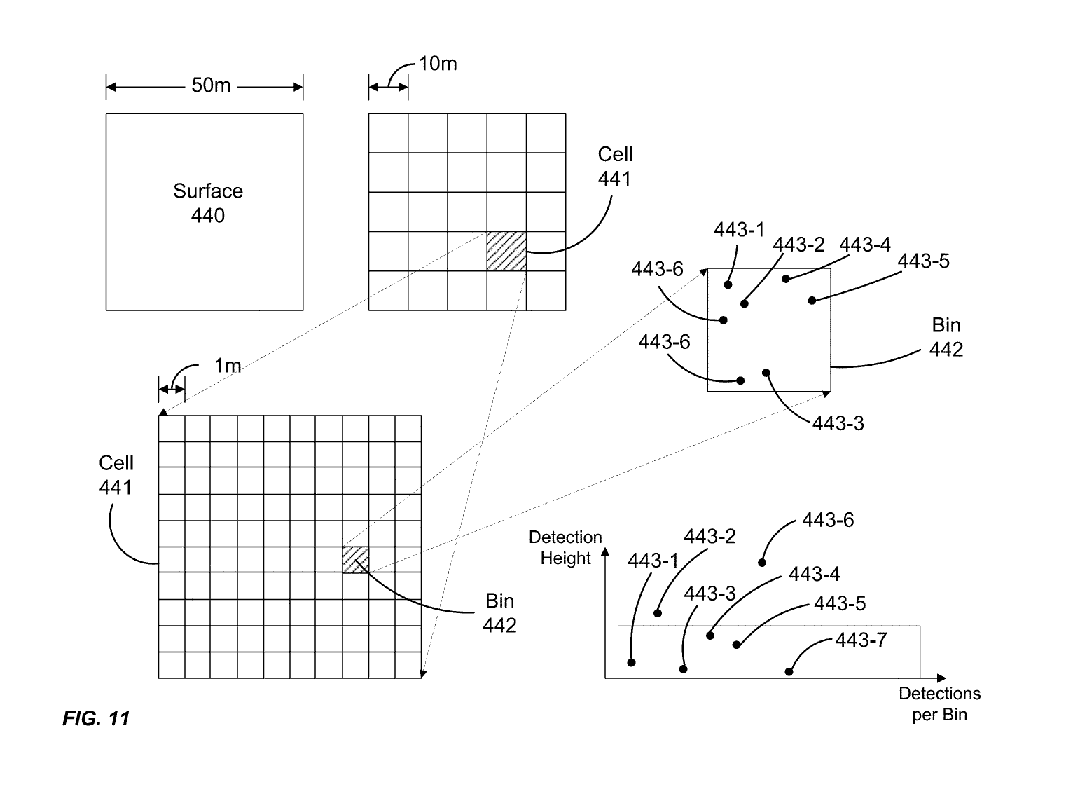

In one exemplary embodiment, the collection model may be a collection of accessible data that includes the vector direction and solid angle Field of View Information (FOVI) for each pixel from a camera and each lidar return from a lidar system. FIG. 9 illustrated how these FOVI change while data is being collected and are calculated using FOVI relative to each sensor 426, sensor 426 orientation information, and a platform 425's orientation and position information (e.g., from a helicopter, a plane, etc.). To illustrate, a j^{th} sensor 426 (2D or 3D) may be mounted to its platform 425 so that it is oriented in a direction \vec{S}_{J}(t) relative to the platform 425's reference frame at a time t. The k^{th} data measurement (either a lidar waveform of a lidar system, or a pixel from an imaging system) is in a direction \vec{sₖ^{(J)}}(t) relative to the overall sensor direction at the time t.

Generally, in an arbitrary world reference system, the j^{th} time-dependent position and orientation may be described by a vector P_{J}(t) and a rotation matrix R_{J}(t). With these parameters described, the direction component of each FOVI (Field of View Information) data element associated with k^{th} data collection from the j^{th} sensor 426 is provided along a path defined by set of positions:

\vec{qₖ^{J}}(tₖ,η)=\vec{P}_{J}(tₖ)+Rⱼ(tₖ)(\vec{S}_{J}(tₖ)+η\vec{sₖ^{(J)}}(tₖ)), Equation (2)

where the time tₖ is the time associated with the k^{th} data collection and η is the length along the path, as illustrated in FIG. 9.

If the sensor system is mounted on a gimbal, the data needed to formulate \vec{S}_{J}(t) at time t is obtained from the gimbal control system. For a camera, each of the vectors \vec{sₖ^{(J)}} may actually be constant in time, whereas a lidar system may provide angular scanner information so that the directional vectors \vec{sₖ^{(J)}}(t) may be determined for waveforms collected from each laser shot. The platform 425's position vector \vec{P}_{J}(t) and rotation matrix R_{J}(t) may be determined from the platform 425's navigation systems (e.g., with respect to land 427). Since data is collected from multiple systems (e.g., the platform 425's navigation systems, gimbals, lidar systems, etc.), interpolation or extrapolation of the data streams may be necessary so that the vector and rotation parameters may be determined at the time associated with a data collection. Time synchronization of data extracted from multiple systems is important where real time analysis is performed. For example, if navigational updates are less frequent than processing of lidar waveform returns, extrapolation of navigational parameters may require the use of Kalman filters or other methods of physical modeling so that sufficiently accurate FOVI directional information may be obtained.

In practice, the data collection model also manages sensor specific calibration or processing functions. For imaging sensors, this may include sensor non-uniformity correction (NUC), in which individual pixel responses are measured and used to produce calibrated signals having the same response to optical fluence for each pixel. Many other well-known methods of processing imaging arrays may be used that require calibration that is specific to the sensor. For example, pixels may be categorized based on their performance, so that “dead pixels” may be eliminated from processing.

For 3D sensors that rely on temporal waveforms from active system for extracting range coordinates (such as lidar), calibration parameters related to data collection may include timing offsets and delays, waveform data sample rates, range response functions, and baseline correction data. Timing offsets and delays include timing data for outgoing pulses and relative system delays between one or more channels measuring outgoing signals and channels measuring incoming signals. These offsets and delays, along with waveform data samples rates, are used to convert signal delays into range distances.

Active systems generally have a range response which may be defined as a range dependent ratio of incoming signal to outgoing signal in the absence of any attenuation. For simple ideal monostatic lidar systems, a range response may have the form 1/r², where r is distance away from the sensor. However, in practice the shape of this response may be more complex due to vignetting and other optical effects. The signal return strength for active system may be calibrated by dividing a range dependent return signal by the range dependent response. Thus, the data collection model uses the context of the specific measurement hardware to process raw data and produce data that has been tagged with orientation, position, or time data so that it can be fused into an accumulated world model.

In processing node 402, the processor 110 updates the collection model. During the course of operation of the processor 110, parameters associated with the interpretation of collected 2D image data and 3D volumetric data may need to be updated with external configuration data (processing node 401). One example includes using global positioning system (GPS) and inertial measurement unit (IMU) inputs to update the position of one or more sensor elements providing the data to the processor 110 (e.g., the sensors 103 and 105 through their respective data sources 102 and 104). Additionally, the processing node 402 may include adjusting calibration parameters to compensate for varying source parameters in active sensing systems.

To illustrate, the collection model may be updated as the sensor 426 moves from a point A (at time t_{A}) to a point B (at time t_{B}). In this case the sensor position has changed, and the sensor pointing direction may have changed as well. When the sensor is at point A, the collection model includes the sensor position and its related sensor pointing information. When the sensor is at point B, the collection model is given by the position of the sensor and its related pointing information. Updating the collection model means associating the new sensor position and pointing information at time t_{B} from the previous sensor position information from time t_{A}.

As discussed earlier, the data collection model may be updated simply by updating the platform 425 position vector, platform 425 orientation, sensor 426 orientation, and relative sensor data collection directions for each subsequent data collection. Additionally, monitoring of sensor health may be used to identify imaging pixels with poor performance which should be eliminated from analysis. For lidar systems, laser energies from each pulse may be individually measured so that return waveforms may be scaled relative to the laser signal energy used.

To illustrate for a moving platform 425 (e.g., a helicopter or a plane), continued updates to the collection model, a volume propagation model (processing node 407), a hard surface position model (processing node 408), and potentially even viewing parameters (processing node 413) depend on the position and orientation of the platform 425. GPS and/or IMU data may be collected and time tagged for association with collected 2D image data and volumetric data. Additional dynamic data that may affect the interpretation of the accumulated data can be obtained from other external sources to support data processing.

Updates to the surface and volumetric models come from the incoming data. As new data arrives, those data are used to augment/update the existing volume or surface models. Data that are determined to be part of the hard surface are used to update the surface model, which is typically treated as a static system. As an example, a surface model may be developed from a set of 3D points. When a new data point is collected it is associated with a set of existing points.

The new 3D point is added to the hard surface via an updating step which may be a simple replacement of old data with new data, or a weighted blending of the new data point with the previously collected data in that region. In this case the data could be the positional coordinates of the points in the region, or the average pixel intensities for those points. In this case the volumetric representation of the obscurant is treated as something that evolves over time. As new data are collected, the associated volumetric data (density, temperature, or other scalar/vector metrics) are updated to represent the current state of the evolving system. For a given point [X, Y, Z] the collection measured at time t_{B} may be different from its value at point t_{A}. In this case, the data would be used to modify the volumetric field typically by replacing the scalar value at time t_{A} with the value at time t_{B}.

In processing node 405, the processor 110 collects 2D image data from a data stream that maps at least one scalar to each of a series of angular coordinates. The angular coordinates may be specified by the previously described \vec{sₖ^{(J)}} vectors. This 2D image data may be camera data but could also include intensity data collected from an angular scanning detector. The 2D image data may also include polarization or spectral information associated with angular coordinates. The 2D image data may include data from multiple 2D image data sources, including historical image data (e.g., an image a scene taken previously from a particular know perspective/vantage point). These data sources could originate from multiple devices configured at separate locations and sensitized to different wavelength bands or different polarizations, or other physical phenomena (e.g., charged particle flux, pressure, temperature, etc.). The 2D image data may be collected in multiple frames at a series of times (e.g., video) so as to provide a video stream of the scene without the obscurant and/or to extract individual frames for rendering images without the obscurant.

Scalar values associated with angular coordinates are often related to electromagnetic energy received at one or more detectors, but the means for collecting that energy may include any number of architectures associated with different phenomenology. However, there is no requirement that received radiation be electromagnetic in nature. Given the appropriate receiver, a 2D image could be formed using acoustic energy, charged particles, or the like. The 2D image data processing node 405 may utilize the data collection model to produce calibrated data that is associated with FOVI specified in a world reference frame.

In processing node 406, the processor 110 collects volumetric data from a data stream that maps a depth sequence to each of a series of angular coordinates. A depth sequence is a mapping of one or more parameters to a series of distances from a specified position. Examples include time series data collected from a lidar system, in which volumetric back scatter along a laser beam path results in a received time dependent signal. By interpreting the delay time for each signal in the time series as the round-trip time of flight for an optical pulse, the time series is modified for use as a distance dependent signal.

Following similar principals, data collected from any active imaging system, such as a radar or a sonar system, may also be used as the volumetric data in the volumetric data source 102. Volumetric data may also be collected through tomographic techniques. In such a case, the organization of the volumetric data into angular and depth coordinates may be the result of computational processing on detector data. Other techniques may include imaging systems such as plenoptic (light field) cameras or those systems that utilize triangulation from multiple perspectives to generate 3D data.

In processing node 411, the processor 110 initiates the world model by including geometric descriptions of surfaces of solid objects. These descriptions may be in the form of multiple primitive shape descriptions, point cloud clusters, spline surfaces, or other parametric representations. The surfaces include at least one other non-geometric property description, including parameters such as color, emissivity, or reflectivity. More advanced descriptions may include parameters for spectral or polarization related reflectivity or emission models. Prior to data collection, the world model may be initiated to include an initial ground representation if a priori data (e.g., Digital Terrain Elevation Data, or “DTED”) is available. Previously collected data on surfaces may be included in the initial world model and initial data may be tagged with confidence factors related to the confidence as to whether that data is still valid.

In processing node 407, the processor 110 collects volume data to update a volume propagation model. For example, a lidar return signal sequence includes backscatter signals from particulates within the laser beam path. The signal sequence may also include a signal corresponding to the reflections from a hard target that blocks the continued propagation of the laser beam. Analysis of the back-scattered signal can be used to calculate a spatially dependent optical attenuation.

For example, the received backscattered signal from a monostatic lidar system may have the functional form Φ_{V}(r)=G(r)β_{π}(r)exp(−2∫₀^{r} αₑₓₜ(ξ)dξ), where G(r) is a range dependent calibration parameter specific to the optical system, r is the range or distance away from the receiver, β_{π}(r) is the range dependent volumetric backscatter coefficient (e.g., units of m⁻¹sr⁻¹), and αₑₓₜ(r) is the range dependent total optical attenuation within the sampled volume.

With this basic propagation model, estimates of the parameters β_{π} and αₑₓₜ within the interrogated volume are maintained over time. Generally, β_{π}(r) and αₑₓₜ(r) are to be extracted from one or more lidar signal returns along different laser paths. If either αₑₓₜ or β_{π} are known, the other is readily computed. However, extraction of both parameters from a single lidar waveform, generally requires additional information. For example, in many media αₑₓₜ and β_{π} may be related by a power law relationship. If it is assumed that β_{π}(r)=B αₑₓₜ(r)^{k}, where β_{π} and k are constants, both αₑₓₜ and β_{π} may be solved for as a function of range along each laser propagation path. Prior to data collection, the parameters B and k may be chosen as constant parameters based on previous phenomenological measurements.

During or after data collection, additional refinement on αₑₓₜ and β_{π} may be obtained by allowing B to have position dependence through incremental variations from its initial constant value. When lidar waveforms are obtained from a moving platform, multiple lidar beam paths may pass through the same volume of air from different angular perspectives. If the lidar measurements are taken with relatively small time delays, a constraint may be added forcing the measured αₑₓₜ and β_{π} to be equivalent from both perspectives.

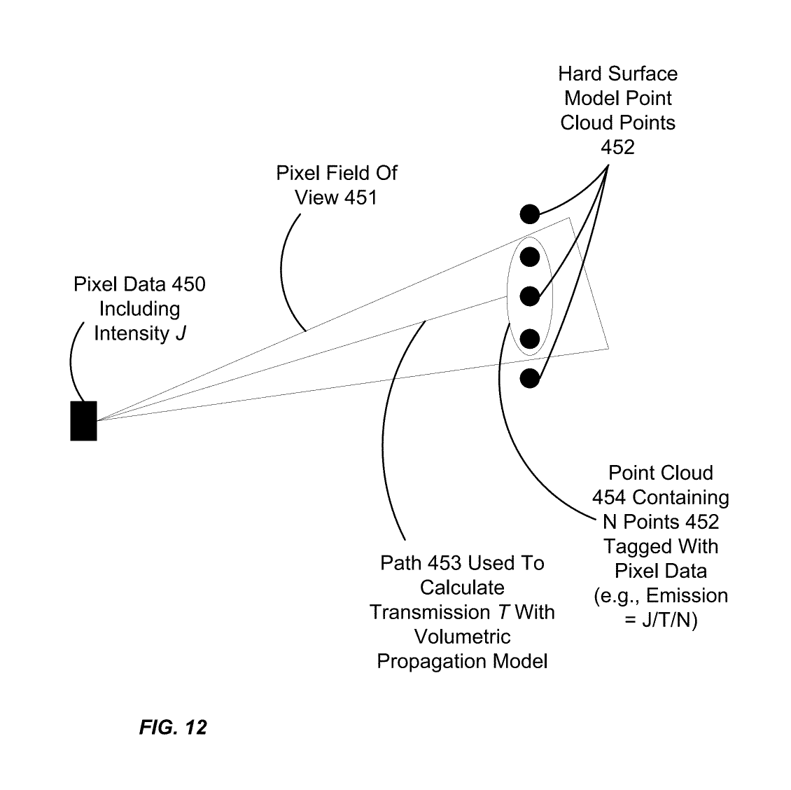

To illustrate, in FIGS. 10A and 10B, each of two lidar returns 433 and 434 from lidar positions 431 and 430, respectively, may be used to produce functional curves 436 and 437 relating B and αₑₓₜ within a commonly sampled volume of air 432. The intercept 435 of those two curves may be used to refine a volumetric dependent B parameter along with αₑₓₜ and β_{π}. Through these methods, the volumetric propagation model may be updated.

The volumetric propagation model may be used at any state of its evolution to provide simulated backscatter and transmission along any path through the previously interrogated volume. Using standard volumetric interpolation algorithms (which may include some spatial filtering), spatially distributed αₑₓₜ and β_{π} measurements may be used to estimate αₑₓₜ and β_{π} as a function of distance along any specific path through the volume. This allows for the estimation of the transmission along any path and at any desired wavelength, given a proper understanding of the optical transmission model at the desired wavelength.

In processing node 409, the processor 110 updates a hard surface position model by retrieving volumetric data that is generally bounded by hard surfaces. In some cases, where hard surfaces are much smaller than illumining sources (e.g., in active lidar or radar systems), hard surfaces may be identified within the detected bounding volume. For active detection, the hard surfaces may be represented by point clouds extracted from time series data. The processor 110 may employ algorithms that recognize point cloud clusters as individual surfaces to create surface geometry representations with a surface position model. The update may be performed by initially combining point clouds with previous point clouds before improving the surface identification steps. Alternatively or additionally, perturbations to previous surface representation may be developed from incremental sets of point clouds. In some instances, contrast in 2D images data may be used to identify 3D surface edges.

The point clouds can be obtained from lidar waveforms by associating each time in a time series with a range and identifying the range at which the signal exceeds some threshold. The threshold itself may be range dependent. Given this range, η, a hard target intercept point may be given by the previously presented equation:

\vec{qₖ^{J}}(tₖ,η)=\vec{P}_{J}(tₖ)+Rⱼ(tₖ)(\vec{S}_{J}(tₖ)+θ\vec{sₖ^{(J)}}(tₖ)). Equation (3)

A large number of points in a point cloud may be grouped together and fit to a surface using standard lidar processing techniques. Surfaces may be simple flat facets or more complicated spline fit curves. These surfaces, specified in a world coordinate system, are catalogued. In addition to surfaces, highly scattering volumes from many hard surfaces that cannot be individually resolved may also be catalogued (e.g., trees, shrubs, etc.). Catalogued elements may have additional tag attributes, such as color, reflectivity, and time of last detection, which can be populated with data as it becomes available.

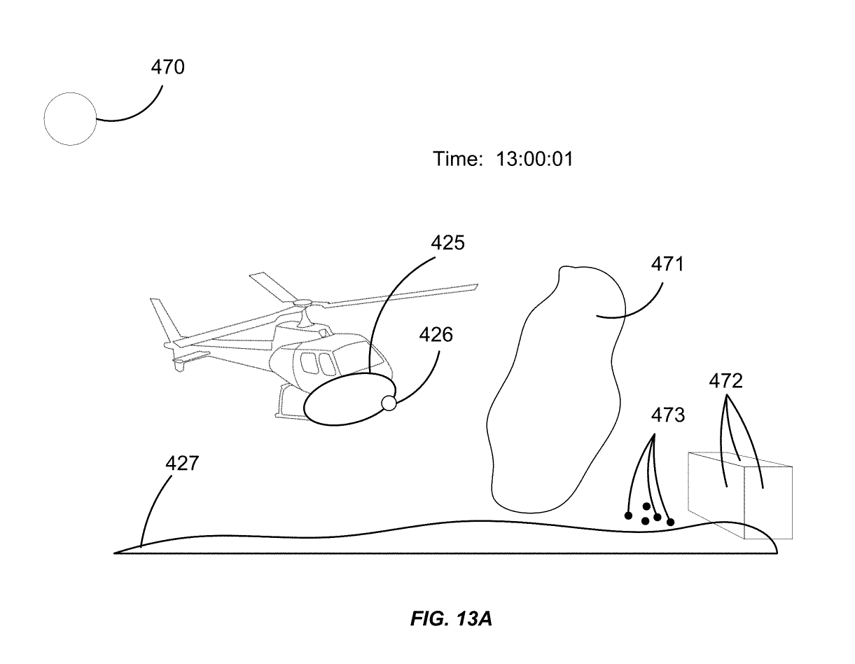

In one example of fitting a surface (e.g., with a 50 m by 50 m dimension) to incoming lidar data, FIG. 11 illustrates lidar points 443-1-443-7 are received and spatially binned into a cell 441 having a certain dimension (e.g., 10 m). Within a cell 441, each point 443 is further refined to a particular height field posting. For each posting, the height is computed as the mean height of the lowest five points in the bin 442. Using five points ensures that there are multiple samples in the bin 442 and guards against updating with the height of a single spurious noise point. The posting height is updated according to the formula below.

$${h}_{new} = \frac{( {h}_{+ x} + {h}_{- x} + {h}_{+ y} + {h}_{- y} + \frac{{h}_{0}}{σ} )}{4 + 1 / σ} , \qquad Equation ( 4 )$$

where h₊ₓ represents the height posting in the adjacent bin in the positive x direction, h₀ is the mean of the five lowest points in the bin 442, and σ is the variance of the five lowest points in the bin 442. The entire surface 440 is continually refined as iterated updates are applied on a periodic basis. The heights for each bin 442 are then used as the vertices of a surface object and subsequently rendered in, for example, OpenGL.

Then, this equation represents an approximation to a Jacobi-style iteration whose fixed point is the solution to the following partial differential equation:

$$Δ h = \frac{h - {h}_{0}}{σ} , \qquad Equation ( 5 )$$

which itself is a Euler-Lagrange equation associated with the stationary point of the function:

$$\int {( \frac{h - {h}_{0}}{σ} )}^{2} + {‖ ∇ h ‖}_{2}^{2} dxdy . \qquad Equation ( 6 )$$

The functional balances data (h₀) and its reliability (σ) with a smoothing term and the iteration causes it to converge to its minimum.

As point cloud data is analyzed, distances of point positions to existing catalogued surfaces may be calculated to determine if a point should be associated with an existing surface or element. Alternatively, new points may be accumulated until additional surfaces are identified and catalogued. Some points that are not associated with surfaces may be determined to be the result of noise and rejected. An alternative approach may also be used, where the points from the point clouds are individually catalogued without attempting to develop surface representations. In this case, some clustering of points within close proximity may still be performed.

In processing node 404, the processor 110 registers volumetric data with 2D imagery. In doing so, the processor 110 extracts hard target positions from the volumetric data and aligns them with the 2D image data in time and space. This registration may provide, for example, an associated 2D image pixel intensity (with associated spectral band) to each angular coordinate associated with the volumetric data. Alternatively or additionally, each pixel intensity within the 2D image data may be associated with an angular coordinate from the volumetric data. Of course, interpolation schemes may be used to associate interpolated intensities from the 2D image data with angular coordinates associated with the volumetric data, and the angular coordinates and volumetric data may be interpolated as well. In any case, at the end of this process, a set of angular coordinates with volumetric information is associated with processed data extracted from 2D image data.

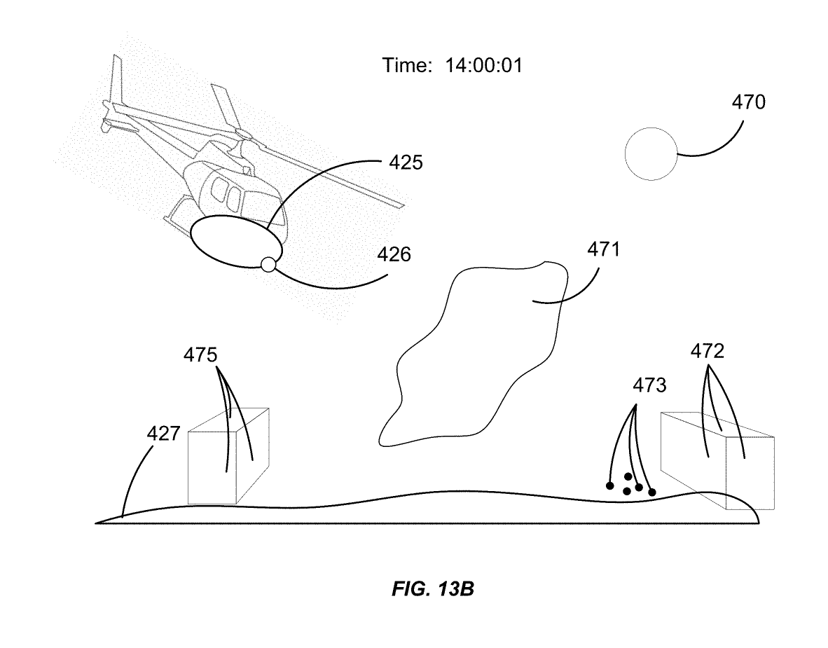

For example, in FIG. 12, a single pixel 450 associated with 2D image data is shown with its respective field of view 451. The pixel 450 could be a physical pixel, or a synthetic representation obtained from interpolated data that includes data obtained over a specific field of view. A pixel index and detection time may be used to tag the points 452 from a hard surface model point cloud 454 that fall within the pixel field of view 451 along a path 453. An image could then be rendered of the point cloud where points 452 in the point cloud have been assigned color and intensity from a 2D image. The resulting data may be rendered from a selected perspective while retaining the passive color imagery information.

In processing node 410, the processor 110 corrects 2D imagery intensity data for 3D distortion effects using the updated volume propagation model. In this regard, the processor 110 corrects surface emission and orientation properties of surfaces for propagation distortions. This process may include determining the angular coordinate dependent transmission to registered surfaces for 2D image data based on an accumulated volumetric representation of attenuation, and dividing image intensity data by this transmission. The resulting corrected image data can then be registered to the volumetric hard target data.

For example, after the points 452 within a point cloud 454 have been tagged by specific pixels 450 that viewed those points at specific times, additional information may also be tagged to the points 452. Using the volume propagation model, the transmission between a point 452 and the pixel 450 may be calculated. A point emission may be calculated for each point 452 (or small cluster of points) by dividing the intensity J received at the pixel 450 by the calculated path transmission T 453 and the number of points N intercepting the pixel field of view 451. This emission value can also be used to tag points 452 from the point cloud 454.

In processing node 408, the processor 110 updates a hard surface optical source model. The purpose of this functional node is to provide parameters to surfaces that allow modeling of surface emissions. Since emissions from the points within the point cloud are tagged with emissions from multiple vantage points (typically from different pixels during platform motion), a directional dependence to the emission may be extracted. If passive illumination conditions are known (e.g., from the solar position at the time of measurements), reflectance parameters for each target may be updated. This may include refining parameters for a surface bidirectional reflectance distribution function (BRDF), spectral or polarization dependent reflectance parameters and/or thermal emission parameters. By using previous imaging and reflectance measurements as measurements of surface properties, the processor 110 may then render the surfaces under different illuminating and viewing configurations than were used to collect the initial data. The surface optical source models are then contained within the world model.

In processing node 413, the processor 110 provides viewing parameters that include the positions and orientations used in rendering simulated imagery. These viewing parameters may be selected by a user, generated by a dynamic algorithm, or some combination thereof. For a moving platform, the position and orientation may be a current or anticipated position and orientation of the platform or a position and orientation from which a simulated platform may be viewed within the context surrounding physical elements. If the rendering is to be viewed with a binocular viewing system, viewing parameters associated with two positions and orientations may be used. Viewing parameters also include illumination parameters which may be different than physical illumination during measurement. For example, even if imagery is obtained during nighttime operations with infrared cameras, viewing parameters may include simulated daytime illumination at visible wavelengths.

In processing node 412, the processor 110 updates the world model with updated hard surface optical source models, as well as updated propagation models specifying volumetric parameters. The processor 110 may also update the world model with time dependent attributes, such as the position and orientation of the sensing platform. In some cases, the world model may include confidence levels for multiple hypotheses on hard target surface positions and properties so that additional information accumulated over time may be used to improve the confidence in accumulated data. Confidence levels may also be used for a statistical analysis on a hypothesis for volumetric atmospheric degradation parameters.

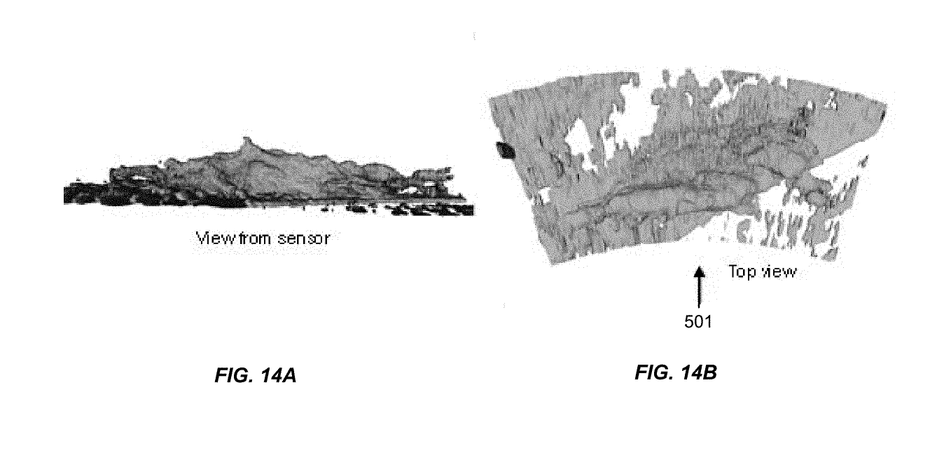

The world model may include its own catalogue of spatially distributed elements. Alternatively or additionally, the world model may manage links to catalogues of elements that are managed by the volumetric propagation model, the hard surface optical model, or the hard surface position model. However, its function is to manage access to estimated renderable element properties at given times. An example of such is shown in FIGS. 13A and 13B.

In FIG. 13A, data may be associated with a time 13:00:01 (hour:minute:second of a 24 hour clock). The world model may track the position of the sun (470) or other known illumination sources, along with the position and orientation of the platform 425. The scattering distributions 471 identified in the volumetric propagation model may have representations within the world model, along with surfaces and clusters of points 473.

The world model may include algorithms that would eliminate or rate elements that have been retained within the hard surface model. For example, point cloud points 473 that have a density too low to be clustered and discriminated from noise may be retained during data collection, since additional data collections may provide an increase in the local density of points revealing a hard object. However, the world model may choose to eliminate these un-clustered points.

Also, previously observed surfaces at the time in FIG. 13A that are proven to be absent in observations occurring at a second later time 14:00:01, as illustrated in FIG. 13B, may be removed from the world model for times after the second time. This observation occurring at the second later time may consist, for example, of a lidar waveform from a path passing through previously observed surfaces 472 and providing a hard object return from a surface 472 that would have been obscured if the previously observed surfaces were still present.

Also illustrated in FIG. 13B, the solar source orientation 470 has changed, the attenuation and back scattering coefficient distributes associated with a scattering volume 471 have drifted, and a new set of surfaces has been identified. Previously viewed points 473 and surfaces 472 that are now obscured by the scattering volume may be retained within the world model if they had been persistent while previously observed. This may serve to distinguish from new surfaces 475 appearing in the scene.

In processing node 414, the processor 110 renders an image. This rendering provides a synthetic view of the world model using the viewing parameter provided by the processing node 413. The rendering may be made for monocular or binocular viewing (e.g. head-down or head-up display, respectively). The rendering may be produced at near real time at steady time intervals utilizing accumulated volumetric and 2D data from earlier times. Rendering may also be performed as a post processing analysis of previously collected data. Rendering may include options for shading with a simulated illumination source and/or allow each surface to emit its own light, depending on desired contrast features.

It should be noted that the discussion in FIG. 8 is merely one exemplary process that may be implemented by the processor 110 to reveal the object 107 being obscured by the material 106 of FIG. 1. The data fusion process described herein may be performed with fewer or more processing nodes than those illustrated in the exemplary embodiment. The order of the processing nodes may also be performed in different orders. Accordingly, the exemplary embodiment of FIG. 8 simply illustrates types of data and how that data may be used by the processor 110 to reveal an obscured object in a scene. A more detailed mathematical discussion now follows to exemplarily illustrate how the world model may be initiated and updated.

Thus, with above general concepts in mind, the processor 110 can propagate a world model of a scene for obscurant characterization. For example, for a single outgoing pulse in a “flying spot” lidar, a small number of ranges (e.g., between 1 and 5) may be recorded for the returning energy along the same “line of sight” (LOS) vector to indicate hard target returns. The waveform returned from a single laser pulse in that lidar also encodes information about the concentration of obscuring materials along the path of the return pulse. For example, a lidar return waveform may demonstrate the detection of a hard target through a distributed obscurant, such as dust, fog, or smoke, because the obscurant can be distinguished from the hard target. Full waveform processing therefore provides for the concentration of the dust to be determined and utilized for greater suppression and to correct the hard target return. Full waveform processing thus enables sophisticated obscurant mitigation techniques (e.g., in Degraded Visual Environments, or “DVEs”).

In addition to suppressing returns from obscurants, the processor 110 of FIG. 1 can estimate the distribution of the obscurant material 106 along the return path and the corresponding optical properties of the material as viewed by the sensors. By scanning the scene, the processor 110 can determine a full volumetric description of the obscurant material 106 and describe how this information can be used to improve the performance of a lidar system and accompanying passive electro-optical (EO) sensors.

To determine the optical parameters (e.g., optical thickness and associated visibility) a propagation model is exploited. The propagation model can be implemented based on certain assumptions. For example, a wave propagating in a medium will undergo scattering and attenuation. If multiple scattering can be ignored, then the solution to a back-scattered power returned at range r is:

$$P ( r ) = \frac{C}{{r}^{2}} β ( r ) {e}^{- 2 {\int }_{0}^{r} α ( r ) dr} , \qquad Equation ( 7 )$$

where C is a constant to account for aperture, transmitted power, etc., β(r) is the volume backscatter and α(r) is the volume extinction (e.g., optical attenuation). To simplify the expression, define

S(r)=ln(r²P(r)) Equation (8)

such that

S(r)=ln(C)+ln(β(r))−2∫₀^{r}α(q)dq, Equation (9)

which can be written as the differential equation

$$\frac{dS}{dr} = \frac{1}{β} \frac{d β}{dr} - 2 α . \qquad Equation ( 10 )$$

If β is constant, meaning the atmosphere or dust was homogeneous and uniform, then α is the slope of the signal return. This assumption has, however, limited applications and usually a power law relationship between α and β is assumed as follows:

β(r)=B(r)α(r)^{k}. Equation (11)

Further assumptions can be made with the power law assumption. For example, k can be made constant throughout the scene as well as B. If the size of the scatterers changes and/or the concentration of these last two assumptions does not hold, the level at which they are violated is generally unknown. Accordingly, this assumption results in:

$$\frac{dS}{dr} = \frac{k}{α} \frac{d α}{dr} - 2 α . \qquad Equation ( 12 )$$

This differential equation results in the following solution for α:

$$α = \frac{{e}^{\frac{S - {S}_{0}}{k}}}{{α}_{0}^{- 1} - \frac{2}{k} {\int }_{{r}_{0}}^{r} \frac{{e}^{S - {S}_{0}}}{k} dq} . \qquad Equation ( 13 )$$

Then, if this equation is integrated “backwards” the processor 110 arrives at:

$$α = \frac{{e}^{\frac{S - {S}_{m}}{k}}}{{α}_{m}^{- 1} - \frac{2}{k} {\int }_{r}^{{r}_{m}} \frac{{e}^{S - {S}_{m}}}{k} dq} , \qquad Equation ( 14 )$$

where rₘ is the lidar's maximum range. This backward formulation is generally stable to perturbations in the recorded signal.

Once the optical extinction parameter is determined, the processor 110 can compute the visual range V from the optical extinction coefficient:

$$V ( r ) ∝ \frac{1}{α ( r )} . \qquad Equation ( 15 )$$

Additionally, the integral of the optical extinction yields the optical thickness of the material 106. The optical thickness of the material 106 that is between the sensors 103 and 105 and a hard target (e.g., the object 107) affects the ability to observe things for both active and passive sensors. Thus, if the processor 110 can characterize the material 106 in terms of optical thickness and/or visibility, then the processor 110 can correct the detected signal to recover an expected “clear air” result.

To extract physical observables more directly related to the material concentration, the model is exploited. For example, a laser light passing through a cloud can be modeled as:

$$I ( r ) = {I}_{0} \frac{{A}_{ap}}{4 π {r}^{2}} f σ c ( r ) {e}^{- 2 {\int }_{0}^{r} ( α + σ ) c ( q ) dq} , \qquad Equation ( 16 )$$

wherein I(r) is the observed intensity return as a function of range r, c(r) is the local concentration of the cloud, I₀ is the intensity of the laser pulse, Aₐₚ is the aperture area at the detector, f is the gain associated with scattering in the reverse direction, σ c(r) is the proportion of light per unit length scattered locally, α c(r) is the proportion of light per unit length absorbed locally, e^{-2∫}^{₀}^{^{r}}^{(α+σ)c(q)dq} is the fraction of light transmitted beyond r with the factor of 2 in the exponent in the above equation capturing the effect of extinction in both directions.

One assumption to the model regards light propagating coherently until it is reflected back to a receiver (e.g., a detector), at which point the falloff is proportional to the inverse of the square of the distance. Another assumption regards scattering and absorption of light being proportional to its concentration. Determining scattering and absorption coefficients directly is, however, not necessary as the optical extinction can be calculated from the data source 102 of FIG. 1 as:

o(r)=(α+σ)c(r). Equation (17)

And, the optical extinction has units of inverse length. So, its reciprocal represents a length scale associated with the extinction of light passing through the material 106, yielding a simplified equation of:

$$I ( r ) = {I}_{0} \frac{o ( r ) {e}^{- 2 {\int }_{0}^{r} o ( q ) dq}}{{Kr}^{2}} , \qquad Equation ( 18 )$$

where

$${K}^{- 1} ≡ \frac{{I}_{o} {A}_{ap}}{4 π} f \frac{σ}{( α + σ )} .$$

Due to the effects of scattering and absorption, K is therefore assumed to be a material property of the substance in the cloud.

Rewriting Equation (18) provides a way to recursively represent the defined optical extinction as:

o(r)=KI(r)r²e^{2∫}^{₀}^{^{r}}^{o(q)dq}. Equation (19)

Accordingly, the optical extinction is directly related to the observed intensity and rescaled to normalize away spherical spreading. The optical extinction also has a monotonically increasing amplification factor that reverses the effect cumulative extinction had in generating the observed intensity profile.

Equation (19) can be rewritten to provide a closed form solution as:

o(r)e^{-2∫}^{₀}^{^{r}}^{o(q)dq}=KI(r)r², Equation (20)

where the left hand side of which can be written as a total derivative as:

$$\frac{- 1}{2} \frac{d}{dr} [ {e}^{- 2 {\int }_{0}^{r} o ( q ) dq} ] = KI ( r ) {r}^{2} . \qquad Equation ( 21 )$$

Integrating Equation (21) yields:

e^{-2∫}^{ₒ}^{^{r}}^{o(q)dq}=C−2K∫₀^{r}l(q)q²dq, Equation (22)

for some constant of integration C. Then, by evaluating the behavior of the expression when r=0, C is generally equal to “1”. Accordingly,

e^{-2∫}^{ₒ}^{^{r}}^{o(q)dq}=1−2K∫₀^{r}(q)q²dq. Equation (23)

Substituting Equation (23) into Equation (19) yields a closed-form solution to Equation (18) as follows:

$$o ( r ) = \frac{KI ( r ) {r}^{2}}{1 - 2 K {\int }_{0}^{r} I ( q ) {q}^{2} dq} . \qquad Equation ( 24 )$$

From there, Equation (24) can be integrated backwards to arrive at:

$$o ( r ) ) = \frac{KI ( r ) {r}^{2}}{1 + 2 K {\int }_{0}^{{r}_{m}} I ( q ) {q}^{2} dq} , \qquad Equation ( 25 )$$

where rₘ is the lidar's maximum range. This backward formulation is stable to perturbations in the recorded signal.

Next, the processor 110 can determine model parameter K from intensity profiles. For example, in Equation (18), K is an unknown parameter. Rewriting Equation (23) results in K as follows:

$$K = \frac{1 - {e}^{- 2 {\int }_{0}^{r} o ( q ) dq}}{2 {\int }_{0}^{r} I ( q ) {q}^{2} dq} , \qquad Equation ( 26 )$$

and K satisfies the inequality:

$$K < \frac{1}{2 {\int }_{0}^{r} I ( q ) {q}^{2} dq} , \qquad Equation ( 27 )$$

for all r>0. However, this inequality may only be valid for intensity returns from the cloud and that r would fall short of including returns from hard targets behind the cloud. Once the optical extinction parameter is determined, the visual range V can be determined via a constant threshold K that an observer needs to distinguish background from the object 107 and by the extinction coefficient of Equation (15).

The processor 110 then determines K from a partially occluded hard target return (e.g., from the object 107). For example, in order to use Equation (26) to determine K, an estimate for the cumulative optical extinction term may be needed. One way to yield such an estimate is to compare the return from a hard target in the absence of a cloud Iₕ with the return from the same target partially occluded by cloud Iₕ* such that K can be estimated as:

$$K = \frac{1 - \frac{{I}_{h}^{*}}{{I}_{h}}}{2 {\int }_{0}^{R} I ( q ) {q}^{2} dq} , \qquad Equation ( 28 )$$

where R falls somewhat short of the bin in which the hard target return is located.

Then, K can be determined from dense cloud profiles. For example, in the case of a particularly dense cloud through which it can be assumed that essentially no light is transmitted, the inequality of Equation (27) is approximately an equality. Accordingly, K can be computed as:

$$K \approx \frac{1}{2 {\int }_{0}^{∞} I ( q ) {q}^{2} dq} . \qquad Equation ( 29 )$$

Equation (29) can be seen as a special case of Equation (28) where the target is completely occluded. In comparison with determining K from a partially occluded hard target return, this method is simpler to exploit in practice because it does not require correlating returns from two profiles. Rather, a single return is used. However, it may only be applicable to profiles where complete extinction has occurred.

Alternatively or additionally, the processor 110 may determine K from the shape of reconstruction. For example, the processor 110 may determine that K involves fitting its value to the shape of reconstructed profiles. This generally requires some data other than the intensity returns to verify a result. Here, the processor 110 could compare the reconstruction to, for example, a video captured of the cloud in profile to ensure that the cloud to be removed from an image is indeed data pertaining to the material 106.

In one embodiment, the processor 110 can employ minimization to estimate optical extinction from lidar returns. For example, the lidar equation has the following form:

$$P ( r ) = \frac{{K}_{s}}{{r}^{2}} β ( r ) {e}^{- 2 {\int }_{0}^{r} ϵ ( {r}^{′} ) {dr}^{′}} , \qquad Equation ( 30 )$$

where P is the observed power at range r, β is the coefficient of backscatter, c is the optical extinction of the obscurant material 106, and Kₛ is a system constant that depends on the pulse energy and area of a lidar receiver. Given observations P(r), Equation (30) is insufficient to uniquely determine both backscatter and extinction simultaneously. So, a power law relationship is asserted between them as follows:

β=K_{β}∈^{γ}, Equation (31)

for constants K and γ, which generally depend on the type of the obscurant material 106. Substituting Equation (31) into Equation (30) yields a simplified lidar equation with no explicit dependence on β. For example,

$$P ( r ) = \frac{K}{{r}^{2}} {ϵ ( r )}^{γ} {e}^{- 2 {\int }_{0}^{r} ϵ ( {r}^{′} ) {dr}^{′}} , \qquad Equation ( 32 )$$

where K=KₛK_{β} is an overall constant depending on the system and the obscurant material 106. And, the exponential factor on the right hand side of Equation (32) represents the cumulative (e.g., two-way) extinction through the obscurant material 106, which is denoted by E as follows:

E(r)=e^{-2∫}^{ₒ}^{^{r}}^{∈(r′)dr′}, Equation (33)

Afterwards, the lidar equation can be inverted. For example, given measurements of P(r), ∈(r) are determined. Then, rearranging Equation (30) results in the following:

$$ϵ ( r ) {e}^{- \frac{2}{γ} {\int }_{0}^{r} ϵ ( {r}^{′} ) {dr}^{′}} = {( \frac{P ( r ) {r}^{2}}{K} )}^{\frac{1}{γ}} . \qquad Equation ( 34 )$$

The left hand side of Equation (34) is a total derivative that results in:

$$- \frac{γ}{2} \frac{d}{dr} ( {e}^{- \frac{2}{γ} {\int }_{0}^{r} ϵ ( {r}^{′} ) {dr}^{′}} ) = {( \frac{P ( r ) {r}^{2}}{K} )}^{\frac{1}{γ}} . \qquad Equation ( 35 )$$

Moving the constant to the right and integrating both sides yields:

$${e}^{- \frac{2}{γ} {\int }_{0}^{r} ϵ ( {r}^{′} ) {dr}^{′}} = C - \frac{2}{γ} {\int }_{0}^{r} {( \frac{P ( {r}^{′} ) {r}^{′2}}{K} )}^{\frac{1}{γ}} {dr}^{′} . \qquad Equation ( 36 )$$

for some constant of integration C. Noting that at r=0, the integral on the right-hand side vanishes, while the left hand side is unity and C=1, such that:

$${e}^{- \frac{2}{γ} {\int }_{0}^{r} ϵ ( {r}^{′} ) {dr}^{′}} = 1 - \frac{2}{γ} {\int }_{0}^{r} {( \frac{P ( {r}^{′} ) {r}^{′2}}{K} )}^{\frac{1}{γ}} {dr}^{′} . \qquad Equation ( 37 )$$

This yields a closed-form solution for a cumulative extinction as follows:

$$E ( r ) = {( 1 - \frac{2}{γ} {\int }_{0}^{r} {( \frac{P ( {r}^{′} ) {r}^{′2}}{K} )}^{\frac{1}{γ}} {dr}^{′} )}^{γ} . \qquad Equation ( 38 )$$

Applying the logarithm and taking derivatives on both sides (or equivalently substituting Equation (37) into Equation (34) and solving for ∈ yields a closed-form expression for the optical extinction as follows:

$$ϵ ( r ) = \frac{( {( \frac{P ( r ) {r}^{2}}{K} )}^{\frac{1}{γ}} )}{1 - \frac{2}{γ} {\int }_{0}^{r} {( \frac{P ( {r}^{′} ) {r}^{′2}}{K} )}^{\frac{1}{γ}} {dr}^{′}} . \qquad Equation ( 39 )$$

Noting that the denominator of Equation (39) is

$${E ( r )}^{\frac{1}{γ}} ,$$

Equation (39) can be rewritten in terms of E(R), the cumulative extinction at range r=R, as follows:

$$ϵ ( r ) = \frac{( {( \frac{P ( r ) {r}^{2}}{K} )}^{\frac{1}{γ}} )}{{E ( r )}^{\frac{1}{γ}} + \frac{2}{γ} {\int }_{r}^{R} {( \frac{P ( {r}^{′} ) {r}^{′2}}{K} )}^{\frac{1}{γ}} {dr}^{′}} , \qquad Equation ( 40 )$$

yielding a “backwards” integration form similar to that provided in Equation (31). However, Equation (40) advantageously accommodates a vanishing P.

Some observations include having power profiles P(r), through the obscurant material 106. Other observations come from hard target returns, P*(R), measured both in the absence of any obscurant (collected during a calibration phase) and in its presence, where it is part of the power profile P(R).

Hard target returns provide a direct estimate of cumulative extinction through the cloud (i.e., the material 106), given by the ratio between the observed return in the presence of the cloud and in its absence as follows:

$$E ( R ) = \frac{P ( R )}{{P}^{*} ( R )} . \qquad Equation ( 41 )$$

The measured power returns are also expected to be polluted by noise \hat{P}=P+n, which is assumed to be independent and identically distributed (IID) random variables with zero mean and standard deviation σ_{P}. Further, it is assumed that during calibration there are enough collected frames to have mapped out the hard target returns in the scene (assumed to be fixed throughout). It is also assumed that scintillation statistics Pᵢ* and σ_{P}_{ᵢ}_{*}≥σ_{P} along each line of sight i containing a hard target return in the system's range.

Under these assumptions, a regularized inversion can be developed according to a functional of the form:

$$D [ ϵ , K , γ ] = {Σ}_{i} \frac{{( {{P}^{′}}_{i}^{*} {E}_{i} - {\hat{P}}_{i} )}^{2}}{( 1 - {E}_{i} ) {σ}_{P}^{2} + {E}_{i} {σ}_{{P}_{i}^{*}}^{2}} + {Σ}_{ij} \frac{{( {P}_{ij} - {\hat{P}}_{ij} )}^{2}}{{σ}_{P}^{2}} . \qquad Equation ( 42 )$$

This functional is formulated as the sum of the squared magnitudes of N(0,1) independent random variables, one for each observation, the total number of which is taken as “N” (e.g., an integer greater than or equal to “1”). As such, the value of D applied to the solution should be close to N. However, the minimizer of D yields a smaller value. The inversion formula attests to the fact that the right-most term in Equation (42) can be made to vanish identically, even with fixed K and γ. The problem is that the presence of noise, combined with the high dimensionality of the solution space, leaves the problem under-determined.

The solution to this lack of determinacy is to augment the problem with regularity conditions, which effectively reduce the dimensionality of the solution space and presumably also capture properties that are desirable in the solution. For example, suppose a second functional B[∈] that measures the “badness” of a solution. Then, the problem may be formulated using both B and D as follows:

$${min}_{ϵ} B [ ϵ ] ∋ D [ ϵ ] \leq N ( 1 + k ) , \qquad Equation ( 43 )$$

for some k>0. This sort of functional may be used for compressed sensing in the presence of noise, in which case the measure of “goodness” is sparsity of representation in some basis set. The informal translation of this problem is: “choose the least bad solution that is sufficiently consistent with the data.” Then, an answer can be recovered by solving Equation (42) under the appropriate circumstances.

One difficulty with Equation (42) is that it is formulated as a constrained minimization problem, which typically requires more complicated methods of solution versus those available for solving unconstrained minimizations. Thus, the problem may be solved as an unconstrained minimization problem as follows:

$${min}_{ϵ} λ B [ ϵ ] + D [ ϵ ] , for some λ > 0. \qquad Equation ( 44 )$$

Of course, there is also the question of what to choose for B[∈]. In the context of compressive sensing, where the focus is on sparsity, variations on the 1-norm are common. The 1-norm also tends to allow solutions that admit jump-type discontinuities, which is a very desirable property in many instances. In the embodiments disclosed herein, however, cloud densities are generally expected to vary smoothly throughout space. Thus, a regularization term is provided of the form:

B[∈]=∥∇∈∥²=∫∇∈·∇∈dx. Equation (45)

The 2-norm, aside from favoring smooth functions, is also differentiable and tends to admit numerical methods. Regularized inversion as described has a several advantages including denoising the data in a principled way. Another advantage is that the regularizer generally guarantees that ∈ is smooth, a desirable condition for having isosurfaces that can be easily visualized. The regularizer also effectively provides a more principled version of the “slope method” for parameter fitting.

To implement this numerically, a proximal version of Equation (44) is employed as follows:

λB[u]+D[v]+μ∫(u−v)²dx, Equation (46)

which can be solved alternately minimizing u and v alone. For example, holding v fixed, a u value that minimizes Equation (46) satisfies:

$$\frac{( I - λ )}{μ Δ} u = v , \qquad Equation ( 47 )$$

an equation similar to the Poisson equation. Like the Poisson equation, this equation permits a simple Gauss-Seidel style method of solution that is easier to parallelize.

For a fixed u, Equation (47) can be minimized via a gradient descent with a line search. This iteration requires a reasonable initialization. Generally, a reverse integration form of Equation (41) is used to initialize E. If hard-target data is available for a given line of sight, then the processor 110 can use its estimate for E(R) and E(R)=1 for other (or all) lines of sight to give an underestimate for ∈.

When an estimate of the system parameters K and γ are desired, another step can be incorporated into the iteration. For example, the only term in Equation (47) that depends on the system parameters is:

$${Σ}_{i , j} \frac{{( {P}_{ij} - {\hat{P}}_{ij} )}^{2}}{{σ}_{P}^{2}} . \qquad Equation ( 48 )$$

Here, it can be shown that the optimal K satisfies:

$$K = \frac{{\sum }_{i , j} {\tilde{P}}_{ij} {\hat{P}}_{ij}}{{\sum }_{i , j} {\tilde{P}}_{ij}^{2}} , where \tilde{P} = \frac{P}{K} = \frac{{ϵ ( r )}^{γ} {e}^{- 2 {\int }_{0}^{r} ϵ ( {r}^{′} ) {dr}^{′}}}{{r}^{2}} . \qquad Equation ( 49 )$$

γ can be updated as well, but the iteration is non-linear and would generally require a gradient descent search.

As noted earlier, the denominator of Equation (39) is a power of the cumulative extinction. As this extinction becomes small and approaches zero, ∈ becomes more difficult to determine and is increasingly subject to noise. Thus, a reasonable rule of thumb for assessing the believability of a reconstructed ∈ is the estimated cumulative extinction to that point. While the cumulative extinction remains sufficiently larger than zero, ∈ should be reliable. Just how sensitive a solution is to noise depends generally on the numerical methods employed. The solution may also depend on errors in the estimates of K and γ.

The processor 110 may then perform a first-order sensitivity analysis by examining perturbations around the solution. The results may illustrate the effect of noise and error accumulation, but its applicability to measured data may remain suspect, as it would likely involve linearizations that are accurate for sufficiently small perturbations. Real-life perturbations are likely to be large enough to make the neglected nonlinearities significant. Thus, reliable sensitivity generally needs to be based on simulation and/or experimental data.

Experimental Results:

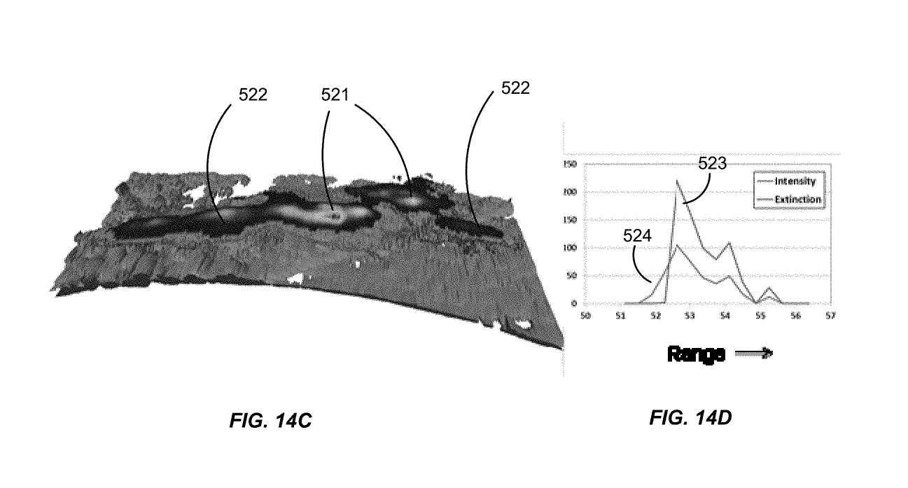

FIGS. 14A-14D illustrate a cloud structure extracted from lidar data. The image in FIG. 14A shows a concentration isosurface of the cloud as viewed from a lidar. The image in FIG. 14B shows the same cloud as viewed from above. The arrow 501 indicates the look direction from the sensor. FIG. 14C illustrate a slice through the cloud structure revealing the concentration map. The areas 521 indicate higher relative dust concentration, and the areas 522 indicate lower relative dust concentration. FIG. 14D illustrates a single range return and the extracted extinction along that range return. Plot 523 indicates the optical extinction as a function of range extracted from the lidar intensity profile shown as plot 524.

These data can then be used in conjunction with 2D image data to modify the displayed data. The lidar data are first registered with the 2D electro optic imagery. Then, lidar waveform data was used to measure the 4D (3D+time) obscurant and create an “atmosphere” model. For example, the measured lidar waveform is of the form:

$$I ( r ) = {I}_{0} \frac{{A}_{ap}}{4 π {r}^{2}} f σ c ( r ) {e}^{- 2 {\int }_{0}^{r} ( α + σ ) c ( q ) dq} . \qquad Equation ( 50 )$$

This waveform is then inverted to find the concentration as follows:

$$o ( r ) = \frac{KI ( r ) {r}^{2}}{1 - 2 K {\int }_{0}^{r} I ( q ) {q}^{2} dq} . \qquad Equation ( 51 )$$

From there, the “atmosphere” model and 3D world can be used to generate a corrected electro optic imagery without the obscurant.

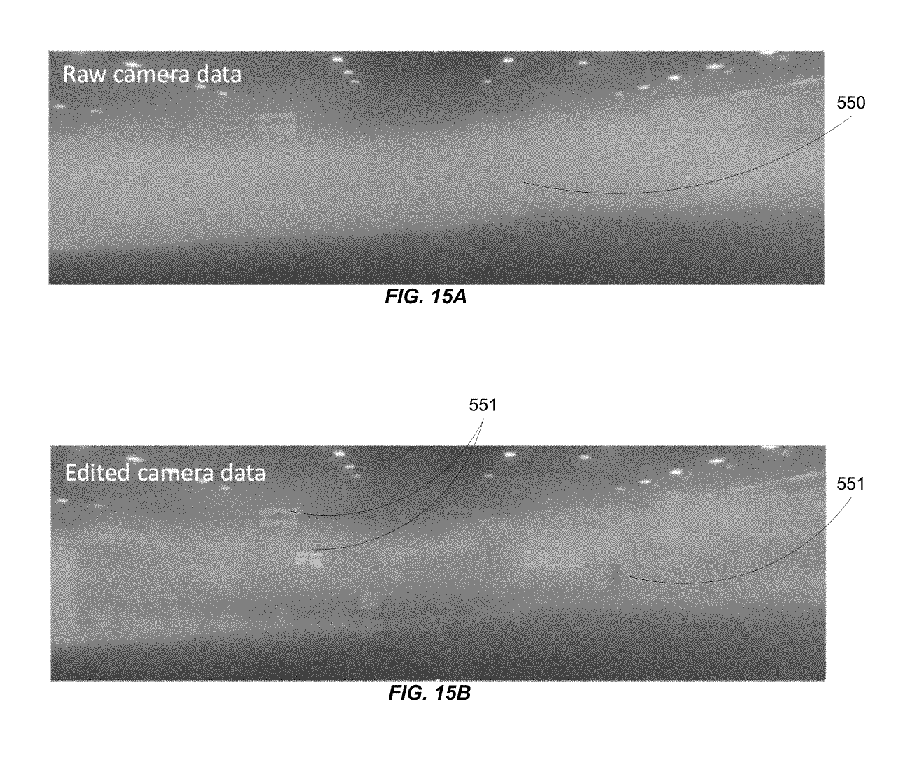

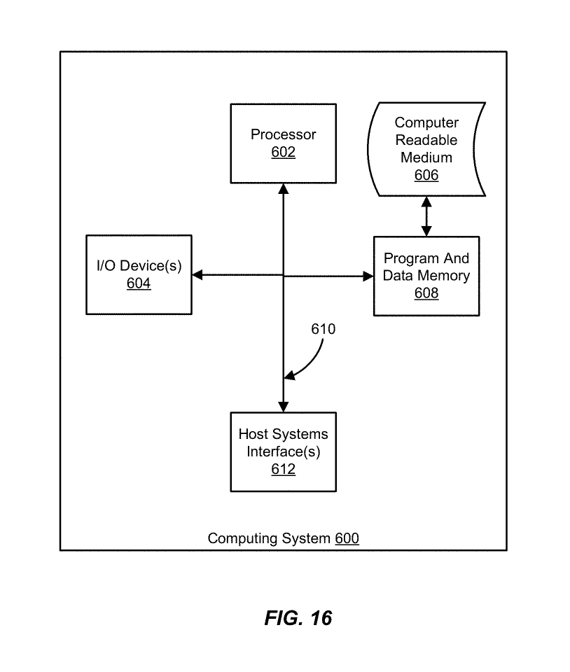

FIGS. 15A and 15B are photographs illustrating exemplary results. In FIG. 13A, raw camera data shows a scene obscured by dust 550. In FIG. 15A, the same scene is illustrated after editing pixels based on the presence of the dust 550. The dust cloud 550 was identified based on a lidar derived dust concentration. Pixels corresponding to those locations were edited based on the above processes to retain their “clear air” information content and reveal the various objects 551 in the scene that were obscured by the dust cloud 550. In this example, the pixels were replaced with pixels from a clear air scene taken prior to dust entering the scene.

As discussed, the systems and methods disclosed herein provide for the identification/imaging of objects being obscured or distorted by distributed materials within the environment. For example, various 2D and 3D sensors (e.g., lidar, radar, sonar, digital cameras, infrared cameras, etc.) can image an object through dust, gas, and/or other obscurants such that the object 107 can be observed or identified. Once the data is collected, the processor 110 generates and maintains a model of surrounding objects and environment that is subsequently used for renderings under differing environmental conditions than were present during the data collection. Applications of this processing are almost boundless. For example, the processor 110 may be used to render imagery for a helicopter pilot so as to remove obscurations by dust and/or other particulates degrading raw image data and/or obscuring the pilots view. Another example includes removing obscurants from a battlefield scene so as to reveal enemy combatants.

The invention can also take the form of an entirely hardware embodiment, an entirely software embodiment or an embodiment containing both hardware and software elements. In one embodiment, the invention is implemented in software, which includes but is not limited to firmware, resident software, microcode, etc. FIG. 14 illustrates a computing system 600 in which a computer readable medium 606 may provide instructions for performing any of the methods disclosed herein.

Furthermore, the invention can take the form of a computer program product accessible from the computer readable medium 606 providing program code for use by or in connection with a computer or any instruction execution system. For the purposes of this description, the computer readable medium 606 can be any apparatus that can tangibly store the program for use by or in connection with the instruction execution system, apparatus, or device, including the computer system 600.

The medium 606 can be any tangible electronic, magnetic, optical, electromagnetic, infrared, or semiconductor system (or apparatus or device). Examples of a computer readable medium 606 include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

The computing system 600, suitable for storing and/or executing program code, can include one or more processors 602 coupled directly or indirectly to memory 608 through a system bus 610. The memory 608 can include local memory employed during actual execution of the program code, bulk storage, and cache memories which provide temporary storage of at least some program code in order to reduce the number of times code is retrieved from bulk storage during execution. Input/output or I/O devices 604 (including but not limited to keyboards, displays, pointing devices, etc.) can be coupled to the system either directly or through intervening I/O controllers. Network adapters may also be coupled to the system to enable the computing system 600 to become coupled to other data processing systems, such as through host systems interfaces 612, or remote printers or storage devices through intervening private or public networks. Modems, cable modem and Ethernet cards are just a few of the currently available types of network adapters.

What is claimed is:

1. A system for imaging obscured objects, the system comprising:
a lidar device operable to provide three dimensional (3D) imaging data of a scene;
a two dimensional (2D) image source comprising 2D image data of the scene; and
a processor operable to detect an object in the scene based on the 3D imaging data, to model a cloud of distributed scatterers obscuring the object in the scene based on the 3D imaging data, to register lidar returns of the 3D imaging data to pixels of the 2D image data, to characterize a material of the cloud of distributed scatterers based on the model, and to alter the pixels of the 2D image data based on the characterization to reveal the object in the scene.

2. The system of claim 1, wherein:
the processor is further operable to format the 2D image data into video frames.

3. The system of claim 1, wherein:
the lidar device and the 2D image source are operable to continually provide data to the processor; and
the processor is further operable to update the model and generate the image in substantially real time based on the continually provided data from the lidar device and the 2D image source.

4. The system of claim 1, further comprising:
a registration data source operable to provide position and orientation information of the 2D image source and the lidar device to the processor, wherein the processor is further operable to register the position and orientation information of the 2D image source and the lidar device in the scene.

5. The system of claim 1, further comprising:
a volumetric data source that provides radar data, sonar data, or a combination thereof, to the processor to update the model.

6. The system of claim 1, wherein:
the 2D image source comprises a camera.

7. The system of claim 6, wherein:
the camera is operable to sense objects in the infrared.

8. The system of claim 7, wherein:
the camera is further operable to sense objects at long wave infrared wavelengths.

9. The system of claim 1, wherein:
the 2D image data is stereographic.

10. A method for imaging obscured objects in a scene, the method comprising:
processing three dimensional (3D) imaging data of the scene from a lidar device;
processing 2D image data of the scene from a two dimensional (2D) image source;
detecting an object in the scene based on the 3D imaging data;
modeling a cloud of distributed scatterers obscuring the object in the scene based on the 3D imaging data;
registering lidar returns of the 3D imaging data to pixels of the 2D image data;
characterizing a material of the cloud of distributed scatterers based on the model; and
altering the pixels of the 2D image data based on the characterization to reveal the object in the scene.

11. The method of claim 10, further comprising:
formatting the 2D image data into video frames.

12. The method of claim 10, wherein:
the lidar device and the 2D image source are operable to continually provide data; and
the method further comprises:
updating the model; and
generating the image in substantially real time based on the continually provided data from the lidar device and the 2D image source.

13. The method of claim 10, further comprising:
processing position and orientation information of the 2D image source and the lidar device; and
registering the position and orientation information of the 2D image source and the lidar device in the scene.

14. The method of claim 10, further comprising:
processing radar data, sonar data, or a combination thereof from a volumetric data source to update the model.

15. The method of claim 10, wherein:
the 2D image source comprises a camera.

16. The method of claim 15, wherein:
the camera is operable to sense objects in the infrared.

17. The method of claim 16, wherein:
the camera is further operable to sense objects at long wave infrared wavelengths.

18. The method of claim 10, wherein:
the 2D image data is stereographic.

19. A non-transitory computer readable medium comprising instruction that, when executed by a processor, direct to the processor to image obscured objects in a scene, the instructions further directing the processor to:
process three dimensional (3D) imaging data of the scene from a lidar device;
process 2D image data of the scene from a two dimensional (2D) image source;
detect an object in the scene based on the 3D imaging data;
model a cloud of distributed scatterers obscuring the object in the scene based on the 3D imaging data;
register lidar returns of the 3D imaging data to pixels of the 2D image data;
characterize a material of the cloud of distributed scatterers based on the model; and
alter the pixels of the 2D image data based on the characterization to reveal the object in the scene.

20. The computer readable medium of claim 19, further comprising instructions that direct the processor to:
process position and orientation information of the 2D image source and the lidar device; and
register the position and orientation information of the 2D image source and the lidar device in the scene.
